(19) United States
(12) Patent Application Publication
(10) Pub. No.: US 2017/0078281 A1
(43) Pub. Date: Mar. 16, 2017

(54) User Login Method and System Capable of Analyzing User Face Validity

(71) Applicant: SOLID YEAR CO., LTD., Taipei City (TW)

(72) Inventors: Mu-Tien LU, New Taipei City (TW); Wei-Hsin TSAI, New Taipei City (TW); Ying-Chieh CHEN, New Taipei City (TW)

(21) Appl. No.: 14/955,982

(22) Filed: Dec. 1, 2015

(30) Foreign Application Priority Data
Sep. 15, 2015 (TW) 104130502

(51) Int. Cl. H04L 29/06; G06K 9/00

(52) U.S. Cl. CPC H04L 63/0861; G06K 9/00268; G06K 9/00288

(57) ABSTRACT

A user login method and system capable of analyzing user face validity is disclosed to request the user provide a digital authentication information containing the username and password and to simultaneously capture the user face instant video streaming, and then to analyze and obtain the valid physiological characteristic information of the user face instant video streaming, and then to get the valid face image from the captured user face instant video streaming, and then to output the valid physiological characteristic information, the valid face image and the digital authentication information for use as valid login credentials, improving the authenticity and accuracy of the login credentials.

### BACKGROUND OF THE INVENTION

1. Field of the Invention

The present invention relates to user login methods for security access and more particularly, to a user login method and system, which analyses the validity of the user face using user face instant video streaming.

2. Description of the Related Art

With the increasing penetration of mobile Internet, development of sophisticated networking technologies for the Internet of Things (IoT), the phenomena of changes in traditional social relations and information media subject to people using social networks and internet media, as well as software and hardware applications of a variety of smart phones, tablet PCs, wearable portable devices, the use of the internet and communication systems has become more and more convenient, rich and diverse. The challenge in the follow-up of the development trend of the aforesaid technologies is how to be able to not only protect the user's digital information security and privacy, but also can improve the reliability of digital information in real time communication.

In a variety of Internet or communication system information security measures, the most common way is that when a user wants to enter a website or create a two-way communication link, the user needs to use username (login name) and password as login credentials so that the receiver, after received the login credentials, can determine whether the user is a legitimate user. If the login credentials are valid, the user is allowed to continue the process, if the login credentials are invalid, the system will stop providing services. This login method has been widely used in a variety of access control applications that requires authentication at the first step. However, people are prone to forget their username and password, or the username and password can easily be stolen by a non-legitimate user. Further, the same username and password may simultaneously have multiple users, credential recipient cannot identify the user's true identity just by the username and the password. In order to ensure login credential security, digital credential recognition has also been used for identifying the true identity of credential holders. Although this method can prevent imposters from using others' login credentials, it requires a corresponding additional hardware equipment to complete the digital credential login procedure, increasing the overall costs of the users and recipients, complicating its implementation, and lowering the use of convenience.

In recent years, the development of biometric technologies for user identity recognition keeps progressing. Biometric identification includes, but not limited to, fingerprint recognition, iris recognition, face recognition, etc. Biometric identifiers are often categorized as physiological versus behavioral characteristics. Physiological characteristics are related to the shape of the body. Regular biometric recognition techniques commonly use user's physiological characteristics as a password for identity recognition. Using user's physiological characteristics as a password has the advantages of anti-theft and prevention of misappropriation and the advantage that everyone carries unique physiological characteristics. In the implementation of face recognition as an example, it is to capture an initial image using an image capture device, and then to find out the face position and face image from the initial image, and then to analyze facial features and to match facial features with a built-in face image, and the login is allowed if both matched.

However, if anyone provides the image capture device with a photo same as the built-in face image according to the above procedure for face recognition, this evil person might fool the face recognition judgment program, leading to fraud. To solve this problem of counterfeiting, TW201033907 discloses a login system that requires the user to make a specific action for enabling an image capture device to capture the action image so that the system can match the captured action image with a living body judgment criteria that is pre-stored in a database. When matched, the user is judged as a living body. This living body judgment method overcomes the aforesaid problem of fraud, however, it causes inconvenience to the user, increasing the time in identification and lowering the identification accuracy. Further, if a hacker cracks the specific action, the hacker can pre-record the action to fool the system.

### SUMMARY OF THE INVENTION

The present invention has been accomplished under the circumstances in view. It is the main object of the present invention to provide a user login method and system capable of analyzing user face validity, which analyzes user face instant video streaming to get valid physiological characteristics and valid face image, enabling the obtained valid physiological characteristic information and valid face image and the digital authentication information provided by the user to be used as valid login credentials, improving the authenticity and accuracy of the login credentials.

To achieved this and other objects of the present invention, a user login method includes the step of letting user make a login request containing a digital authentication information, the step of capturing the user's face instant video streaming, the step of analyzing and validating valid physiological characteristic information of the user face instant video streaming and capturing a valid face image of a part of the instant video streaming, and the step of outputting the valid physiological characteristic information, the valid face image and the digital authentication information to a receiver unit so that the receiver unit can determine to accept or reject the login request.

Preferably, the face validity analysis program transform time domain pairwise interactions in the user face instant video streaming to the frequency domain for analysis.

Preferably, the implemented of the user login method is achieved by analyzing the time-based correlation between images of the user face instant video streaming to obtain physiological characteristics and then determining the face images to be valid or invalid by analyzing the physiological characteristics thus obtained to be within a normal range of a human body.

To achieve this and other objects of the present invention, a user login system using the aforesaid user login method comprises a transmitter unit and a processor unit. The transmitter unit comprises streaming video capture module adapted for capturing the user's face instant video streaming. The processor unit is adapted for analyzing the user's face instant video streaming, capturing the valid physiological characteristic information and the valid face image, and then and outputting the valid physiological characteristic information and the valid face image and the digital authentication information that is inputted into a login request by the user.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a system block diagram of a user login system in accordance with the present invention.

FIG. 2 is a flow diagram of a user login method in accordance with the present invention (I).

FIG. 3 is a flow diagram of a user login method in accordance with the present invention (II).

### DETAILED DESCRIPTION OF THE INVENTION

Prior to reading the following detailed description of the invention, it is to be understood that the embodiment described hereinafter is not intended to limit the implementation of the invention to the environment, application or method described. The description of the preferred embodiment is simply for describing the technical features of the invention but not intended for use to limit the scope of the invention. To any person skilled in the art, it is obvious that various alternate forms can be implemented without specific details. In the following preferred embodiment and the annexed drawings, the programs that are not directly related to the present invention have been omitted.

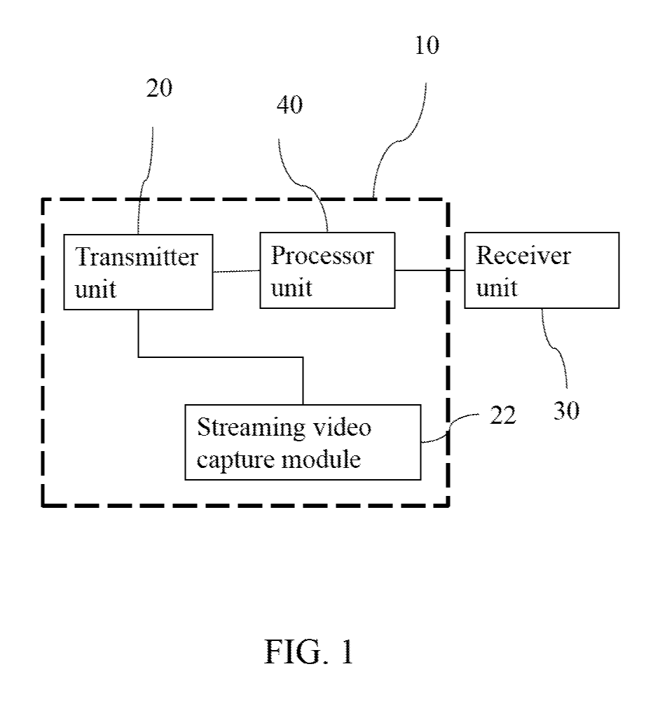

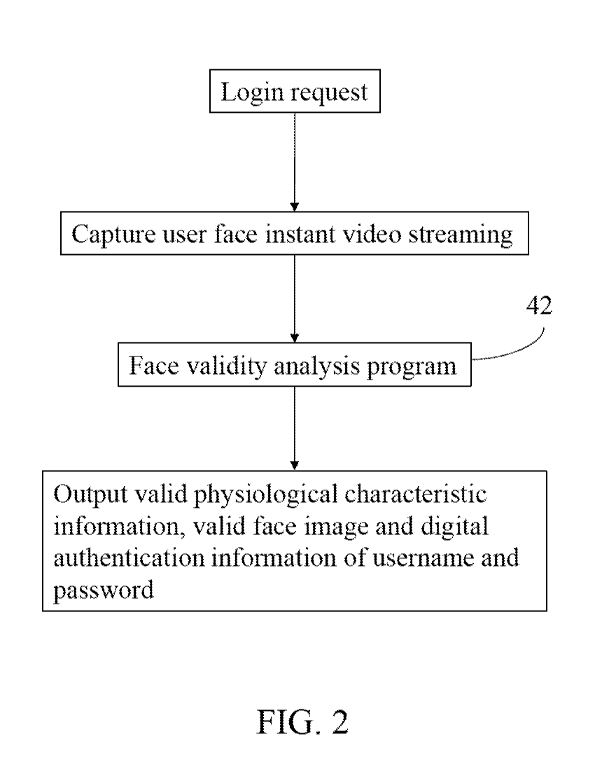

Referring to FIGS. 1 and 2, a user login system 10 capable of analyzing user face validity in accordance with the present invention generally comprises a transmitter unit 20 and a processor unit 40. The transmitter unit 20 can be a communication device or computer equipment connectable to the Internet, comprising a streaming video capture module 22 for capturing an instant video streaming from the face of a user. The processor unit 40 comprises a face validity analysis program 42 adapted for analyzing the user face instant video streaming captured by the streaming video capture module 22 to get a valid physiological characteristic information from the user face instant video streaming, and then actively capturing a valid face image from the instant video streaming, and then transmitting the valid physiological characteristic information, the actively captured valid face image and the digital credential information of the username and password logged by the user to a receiver unit 30. The receiver unit 30 can be a communication device or a computer equipment or server connected to the Internet for receiving the valid login credentials that are transmitted by the transmitter unit 20 and analyzed by the processor unit 40. The receiver unit 30 can record the valid login credentials for further queries, or show the valid face image in accordance with the user's Internet behavior for user identity identification, The receiver unit 30 can determine to accept or reject the login request using an automatic or manual estimation technique, determine the priority of this user, and record this user's login request in the database.

When a user wishes to use the user login system 10 and to link the transmitter unit 20 of the user login system 10 to a remote receiver unit 30, the user login method of the invention includes, at first, the step of letting the user tell the transmitter unit 20 which receiver unit 30 to be connected and providing a login request, and then the step of enabling the transmitter unit 20 wakes up the streaming video capture module 22 to capture the user face instant video streaming. The digital credential information for the login request contains, but not limited to, username and password. Thereafter, the transmitter unit 20 provides the username and password with the user face instant video streaming to the processor unit 40 for recognition. Therefore, the processor unit 40 runs the face validity analysis program 42 to recognize that the instant video streaming is a human face, and then to validate the valid physiological characteristic information of the user face instant video streaming and to capture an valid face image of a part of the instant video streaming, and then to output the valid physiological characteristic information, the valid face image and the username and password of the valid login credentials to the receiver unit 30, receiver unit 30 to record the valid login credentials for further queries, or to show the valid face image in accordance with the user's Internet behavior for user identity identification. Further, the receiver unit 30 can work with an authentication system to decide to accept or reject the login request.

The face validity analysis program 42 of the processor unit 40 in accordance with the present invention can analyze and capture the user's physiological characteristic information. The face validity analysis program transforms time domain pairwise interactions in the user face instant video streaming to the frequency domain for analysis, and captures the representative for frequency inversion. The user's physiological characteristic information to be captured and analyzed in this embodiment is based on the user's heart rate and respiratory rate as an example. However, this example is not a limitation. The valid physiological characteristic information refers to the match of the captured user physiological characteristic information with the normal respiratory rate and heart rate of people in general, the normal respiratory rate for a healthy adult at rest is 16-20 breaths per minute; the normal heart rate is about 50-100 beats per minute. Any captured user's physiological characteristic information that surpasses this range is regarded as invalid physiological characteristic information, otherwise it is valid physiological characteristic information.

The valid face image in this embodiment is the image actively captured by the processor unit 40 from the user face instant video streaming during its analysis.

The validity of spatial domain is the use of face detection algorithm to confirm the image contains a face image. The validity of time domain refers to the pairwise correlation between images. In this embodiment, the respiratory rate and heart rate are measured from the face images by analyzing the time-based correlation between images, and the face image is determined to be valid or invalid subject the measured respiratory rate and heart rate, i.e., to confirm the respiratory rate and the heart rate are in the normal range, and then to actively capture one or multiple valid face images, or to disregard the images if they are invalid.

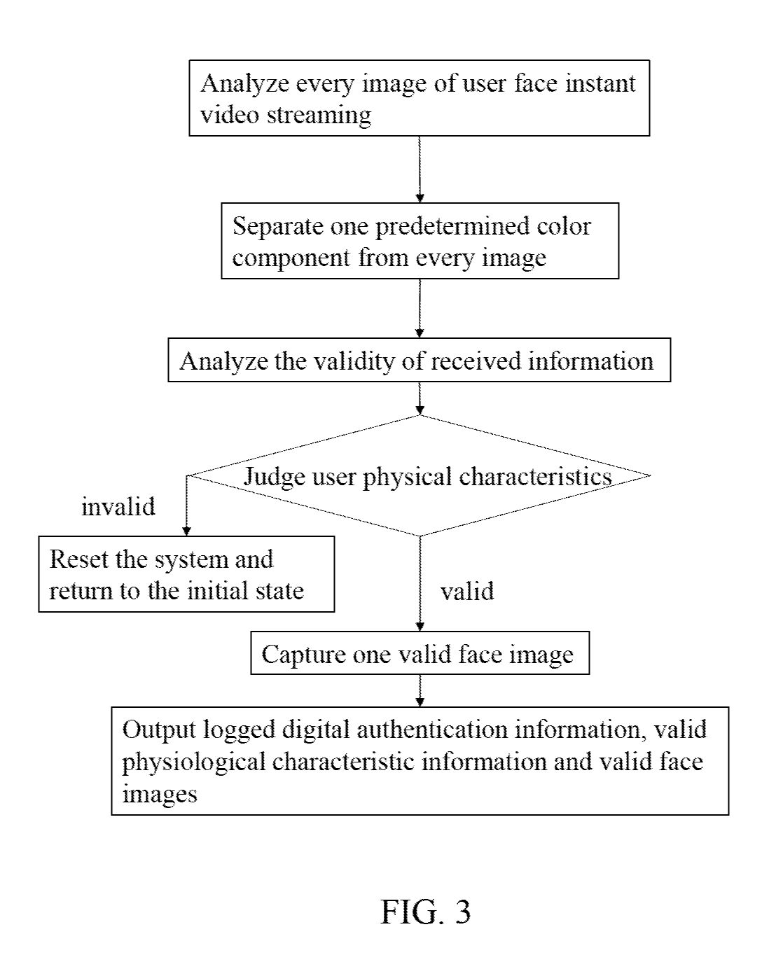

More specifically, as illustrated in FIG. 3, the face validity analysis program includes the steps described below. At first, use a face detection algorithm to analyze the face information contained in every face image in the captured user face instant video streaming, and then to separate one predetermined color component from every image, such as green color, red color, blue color or YUV color model, and to simultaneously output the data of number of face, coordinates and diameter to a face validity judgment program for analysis so that the face validity judgment program can judge the validity of the received information, i.e., the information is valid and the follow-up procedure is continued if the number of face is 1 and the diameter is larger than a predetermined range. If the information is invalid, the system is reset to return to the initial state.

The determination of the user's heart rate and respiratory rate is achieved by using the coordinates and the diameter of the face to find effective skin range, and then to transform the time domain intensity information within the effective skin range to frequency domain using Fourier transform or Wavelet Transform for analysis of their spectral characteristics and allocation of the representative frequency band and then conversion into respiratory rate and heart rate. Heart rate and respiratory rate are judged using a range determination method, for example, the normal heart rate is in the range of 50-100 beats per minute and the normal respiratory rate is in the range of 16-20 breaths per minute, and a predetermined error value is added within this range to achieve the judgment. Finally, capture a valid face image through a face capture program with the face coordinate and diameter information provided by the face detection algorithm. Through the aforesaid face validity analysis program, it allows a user to input digital authentication information for login, enabling the user face instant video streaming to be converted into login request digital authentication information, heart rate and respiratory rate and valid face image. Face detection algorithm is simply an example but not intended for use to limit the scope of the invention.

In an application example of the present invention for website login, the user uses the transmitter unit 20 to provide a digital credential information containing at least username and password for login, and then uses the streaming video capture module 22 of the transmitter unit 20 to capture the user face instant video streaming and provide the captured user face instant video streaming to the processor unit 40 so that the face validity analysis program can analyze the physiological characteristics of the user face instant video streaming (including face detection, respiratory rate, heart rate, . . . etc.). Under the condition that the analyzed respiratory frequency is within the respiratory frequency normal range and the analyzed heart rate is within the heart rate normal range, the system actively captures one or multiple valid face images from the user face instant video streaming, and then transmits the logged digital authentication information, valid physiological characteristic information and actively captured valid face images to the receiver unit 30. At final, after received the logged digital authentication information, valid physiological characteristic information and actively captured valid face images, the receiver unit 30 decides to receive or reject the login request using an automatic or manual judgment method, determines the priority of this user, and records this user's login request in the database.

The invention allows the face validity analysis program to be implemented in the transmitter unit, an external receiver unit or cloud system. Further, using the face validity analysis program to analyze the time domain of the user face instant video streaming and using the time between images as a reference to infer heart rate and respiratory rate can significantly improve the identification accuracy and the operation speed. The present invention directly analyzes the physiological characteristic information, and the one who logged in is regarded as a different person if the physical characteristic information is not matched. Coupled with the username and password, the invention not only ensures the authenticity of identification, but also is able to distinguish between real person and dummy/photo. Further, by means of recording user physiological characteristics, the invention enhances the reliability of judgment and achieves improvement on login authenticity and accuracy.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A user login method, comprising the steps of:
a. letting a user make a login request containing a digital authentication information;
b. capturing the user's face instant video streaming;
c. analyzing and validating valid physiological characteristic information of the user face instant video streaming and capturing a valid time-based image of a part of said instant video streaming; and
d. outputting said valid physiological characteristic information, said valid face image and said digital authentication information.

2. The user login method as claimed in claim 1, wherein the implementation of step c is to transform time domain pairwise interactions in said user face instant video streaming to the frequency domain for analysis.

3. The user login method as claimed in claim 1, further comprising, after step d, a step of recording said valid physiological characteristic information, said valid face image and said digital authentication information.

4. The user login method as claimed in claim 1, further comprising, after step d, a step of displaying said valid face image.

5. The user login method as claimed in claim 1, wherein step c is implemented by analyzing the time-based correlation between images of said user face instant video streaming to obtain physiological characteristics and then determining the face images to be valid or invalid by analyzing the physiological characteristics thus obtained to be within a normal range of a human body.

6. The user login method as claimed in claim 1, wherein step c further comprising the procedure of analyzing every image of said user face instant video streaming, and then separating one predetermined color component from every image and judging the validity of the image, and then transforming the time domain intensity information within the effective skin range to frequency domain and analyzing the spectral characteristics for conversion into said physiological characteristics.

7. The user login method as claimed in claim 1, wherein said physiological characteristic is respiratory rate or heart rate.

8. The user login method as claimed in claim 7, wherein the judgment of said respiratory rate and said heat rate adopts interval judgment.

9. A user login system using the user login method as claimed in claim 1, the user login system comprising:
a transmitter unit comprising a streaming video capture module adapted for capturing said user's face instant video streaming; and
a processor unit adapted for analyzing said user face instant video streaming and capturing and outputting said valid physiological characteristic information, said valid face image and said digital authentication information.

10. The user login system as claimed in claim 9, further comprising a receiver unit adapted for recording said valid physiological characteristic information, said valid face image and said digital authentication information, or displaying said valid face image.
